(19) United States
(12) Patent Application Publication
(10) Pub. No.: US 2009/0140080 A1
(43) Pub. Date: Jun. 4, 2009

(54) OPTIMIZED ARMATURE ASSEMBLY GUIDANCE FOR SOLENOID VALVES

(76) Inventor: Friedrich Howey, Ditzingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/093,027

(22) PCT Filed: Sep. 27, 2006
(86) PCT No.: PCT/EP2006/066780

§ 371 Date: Sep. 12, 2008

(30) Foreign Application Priority Data
Nov. 8, 2005 (DE) 10 2005 053 115.6

(51) Int. Cl. F02M 51/06

(52) U.S. Cl. 239/585.5

(57) ABSTRACT

The invention relates to a fuel injector having a solenoid valve which actuates a multi-part armature assembly. The armature assembly comprises an armature bolt, an armature bolt which is acted on by a valve spring, and an armature plate. As a result of the lifting motion of the armature bolt, a closing element is opened or closed, whereby an injection valve member can be actuated, in order to relieve the pressure in a control space. The armature plate is guided, decoupled from the armature bolt, on an armature guide.

### PRIOR ART

DE 196 50 865 A1 describes a solenoid valve for controlling the fuel pressure in a control chamber of an injection valve, for example in a common rail injection system. The fuel pressure in the control chamber controls a stroke motion of a valve piston that opens or closes an injection opening of the injection valve. The solenoid valve includes an electromagnet, a movable armature, and a valve member that is moved along with the armature, acted on in the closing direction by a valve closing spring, and cooperates with the valve seat of the solenoid valve, thus controlling the outflow of fuel from the control chamber.

There is a known common rail injector equipped with a two-part armature that is attracted by a solenoid valve. In the currentless state, the armature exerts the closing force on a valve ball. When current is supplied to the electromagnet, the armature moves upward by the armature stroke, the closing force of the closing force acting on the valve ball becomes 0,and an outflow valve opens. The armature pin is accommodated in an armature guide that is screw-mounted in the injector body of the fuel injector. The armature plate, which is in turn attracted by the electromagnet, is guided on the armature pin. Because of the guidance play, the armature pin can tilt in the armature guide. The armature plate can in turn tilt on the armature pin so that the overall tilt of the armature pin/armature plate subassembly with respect to the main axis of the injector, for example, can be calculated as the sum of the guidance plays.

The armature plate has a definite excess stroke stop on the armature guide that conveys the kinetic energy of the movement of the armature, which occurs after the electromagnet is switched off, out of the system. When the valve ball comes to rest in its seat, the armature pin is stopped in its movement. The armature plate can still continue traveling by the amount of the excess stroke (ballistic operating phase) before the plate comes into contact with the excess stroke stop. Consequently, only part of the kinetic energy from the movement of the armature pin has to be dissipated in the valve seat. The part of the kinetic energy from the armature plate is dissipated in the injector body.

In current mass-produced units, the problem arises that the valve spring exerting a closing force on the armature pin introduces transverse force components into the subassembly composed of the armature plate and armature pin. Depending on the guidance play between the armature guide and the armature pin, this leads to a tilting of the armature pin in the armature guide. With a powerful transverse force, this tilting can also occur in the upper position of the armature pin when the electromagnet is being supplied with current since an armature pin stop can rest against one side. As a result, full use is not made of part of the set armature stroke i.e. the movement of the armature pin during operation. This results in a smaller injection quantity of fuel into the combustion chamber of an internal combustion engine. This is accompanied by the friction of the armature pin in the armature guide, which likewise influences the movement of the armature pin. This friction increases with a larger tilt angle a since there is likewise an increase in the lever arm of the force to be disengaged. The engagement point of the valve spring is spaced a relatively large distance from the upper end of the armature guide. As a result, at the upper and lower end of the armature guide, very powerful forces acting on specific points are exerted on the armature pin, which increase the friction and consequently slow the movement of the armature pin. The speed with which the armature pin moves, i.e. the opening and closing of the valve ball, has a very large influence on the injection quantity that is fed into the combustion chamber of the internal combustion engine.

In order to master this problem, in some experiments, the guidance play has been limited with the aim of reducing the tilt angle. A limitation of the guidance play would in turn result in the fact that the armature pin would not be able to maintain a constant position during operation, but instead would assume a different position from injection to injection. This is accompanied by a changing friction between the armature pin and armature guide and thus leads to a variation in the injection quantities.

It has also turned out that due to the above-described overall tilting of the armature plate and armature pin by the tilt angle a relative to the main axis of the injector, a collision can occur between the armature plate and the solenoid core when there are small residual air gaps remaining between the armature plate and the solenoid core and on the other hand, a residual air gap that is not uniform over the circumference results in a magnetic force that is unevenly distributed over the circumference. This increases the randomly occurring friction forces and therefore influences the quantities of fuel injected into the combustion chamber of the internal combustion engine by the fuel injector. In addition, the unevenly distributed magnetic force also causes a bending of the armature pin and therefore results in a lower-quality armature guidance since higher friction force components are generated.

### DISCLOSURE OF THE INVENTION

The object of the present invention, therefore, is to eliminate the disadvantages inherent in the embodiments of the prior art and to create an armature guidance of a multi-part armature subassembly for a solenoid valve that actuates a fuel injector, which on the one hand makes full use of the stroke of the armature pin and minimizes the tilt of the armature subassembly that occurs with respect to the main axis, e.g. of the fuel injector. To this end, in a two-part armature subassembly including an armature pin and an armature plate, according to the present invention, the armature plate is equipped With a guidance that is independent from the armature pin while the distance of the force engagement point of a valve spring of the solenoid valve with the armature pin is shifted toward the upper end of an armature guide. This significantly reduces the distance of the engagement point of the valve spring from the upper end of the armature guide. This results in the fact that while the lateral forces of the spring remain the same, the lateral forces occurring in the armature guide are reduced, thus significantly reducing the friction between the armature pin and the armature guide encompassing it. With the same amount of guidance play, the tilt between the elongated armature guide and the armature pin is significantly reduced. Another advantageous effect of the embodiment according to the invention is that it significantly reduces the lever arm that occurs due to a tilt, thus also contributing to a reduction in the friction between the two-part armature subassembly, in particular the armature pin and the armature guide encompassing it.

Because the armature plate is guided so that it is decoupled from the armature pin, the maximum tilt of the armature plate decreases. Magnetic forces acting in an uneven fashion on the armature plate of the two-part armature subassembly can be exerted on the guide that guides the armature plate, specifically on the outside of the armature guide, and therefore do not contribute to a bending of the armature pin, which is encompassed by the elongated armature guide according to the invention. Due to the reduction of the transverse forces acting on the armature pin, the armature pin can move with greater ease in relation to the elongated armature guide, thus making it possible to implement reproducible injection quantities since the minimizing of the lateral forces results in a more easily moving guidance of the armature pin in the elongated armature guide encompassing it. On the one hand, the elongated armature guide that encompasses the armature pin of the two-part armature subassembly improves the ease of movement of the armature pin movement inside the armature guide due to the achievable reduction in the transverse forces and on the other hand, the elongated armature guide provides the guidance for the armature plate of the multi-part armature subassembly. Due to the guidance of the armature plate on the outer circumference surface of the elongated armature guide, transverse forces induced by the armature plate do not act on the armature pin movably contained inside the armature guide and therefore do not hinder its movement, but are instead absorbed by the outer circumference surface of the elongated armature guide.

### DRAWINGS

The invention will be described in greater detail below in conjunction with the drawings.

FIG. 1 shows the influence of the guidance play between the armature pin and an armature guide embodied according to the prior art as well as an exaggerated depiction of the tilting of the armature pin in relation to the armature guide,

FIG. 2 shows a section through a solenoid valve, which is equipped with the armature subassembly according to the invention and the elongated armature guide,

FIG. 3 is a component depiction of the elongated armature guide,

FIG. 4 is a top view of an armature plate of a multi-part armature subassembly, and

FIG. 5 shows the section V-V shown in FIG. 4 through the armature plate.

### EXEMPLARY EMBODIMENT

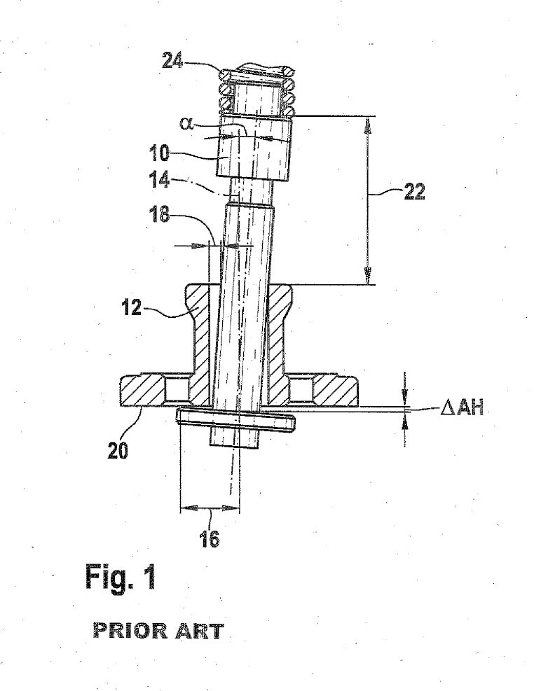

The depiction in FIG. 1 is an enlarged depiction of the influence of the guidance play between the armature pin, whose armature plate is not shown, and an armature guide according to the prior art.

FIG. 1 shows an armature pin 10 that is encompassed by an armature guide 12. A valve spring 24 acts on the armature pin 10. The upper annular surface of the armature guide 12 and the force introduction point of the valve spring 24 are spaced apart by a distance 22. The lateral forces occurring between the armature pin 10 and the armature guide 12 decrease as the distance 22 decreases. According to the configuration shown in FIG. 1, a guidance play 18 prevails between the outer circumference surface of the armature pin 10 and the inner circumference surface of the armature guide 12. In FIG. 1, the armature pin 10 is depicted tilting with a tilt angle a in relation to a main axis 14 of the injector. The tilt, which is depicted on an enlarged scale in FIG. 1, produces a tilted position of the armature pin 10 inside the armature guide 12 encompassing it, resulting in a difficulty of movement of the armature pin 10 due to the resulting friction against the armature guide 12, and also yielding an unused armature stroke distance ΔAH. The unused armature stroke distance AAH cannot be used in the stroke movement of the armature pin 10 in relation to the stationary armature guide 12 and does not contribute to the stroke path of the armature pin 10 and therefore does not contribute to the opening movement of a valve member to be opened or closed.

The lever arm that causes the tilting of the armature pin 10 to result in an unused armature stroke distance ΔAH is labeled with the reference numeral 16 and extends between the symmetry axis of the armature pin 10 and the outer end of its stop surface 38.

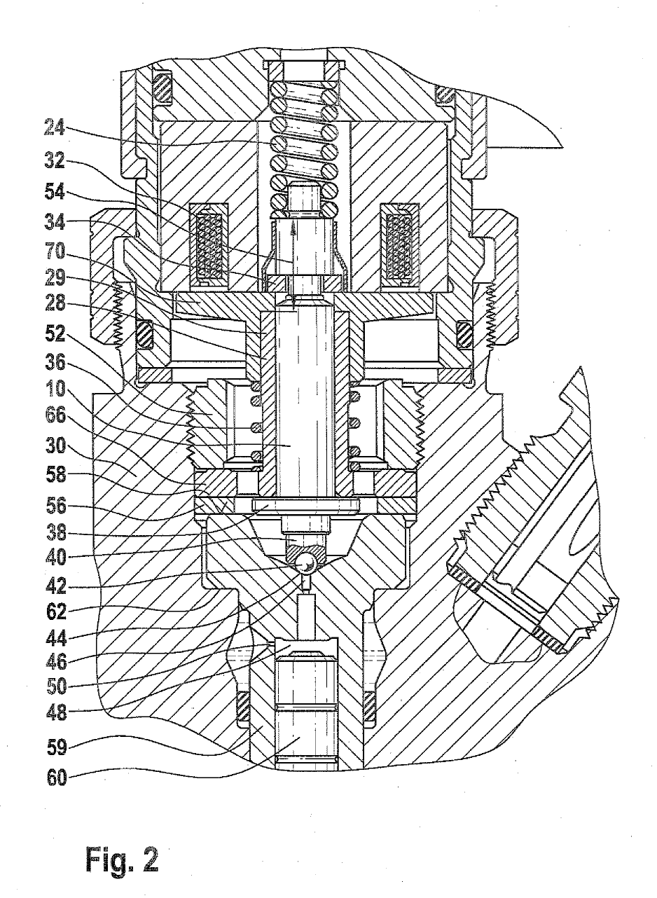

The depiction in FIG. 2 shows a section through a solenoid valve that actuates a fuel injector, equipped with the armature subassembly according to the invention and an elongated armature guide.

The injector body 30 of a fuel injector contains a solenoid valve, which includes an electromagnet 32. Beneath the electromagnet 32, there is a two-part armature subassembly that includes the armature pin 10 and an armature plate 70. The armature pin 10 is encompassed by an elongated armature guide 28. The armature plate 70 is guided on the outer circumference surface of a neck 29 of the elongated armature guide 28. The valve spring 24 acts on the armature pin 10. The distance of the force engagement point of the valve spring 24 and the top surface of the upper end of the elongated armature guide 28 is labeled with the reference numeral 54 and is significantly shorter than the distance 22 shown in FIG. 1 between the force engagement point of the valve spring 24 and the armature guide 12 according to prior art depicted therein.

According to the depiction in FIG. 2, an armature plate spring 36, which is in turn supported on a disk-shaped mount 66 of the elongated armature guide, prestresses the armature plate 70. The disk-shaped mount 66 of the elongated armature guide 28 is screw-mounted by means of a clamping screw 52 on an aligning washer 56 previously inserted into the injector body 30, thus fixing it in the injector body 30. The aligning washer 56, which can, for example be a size-classified aligning washer, defines the armature stroke distance.

The movement of the armature plate 70 is limited at the top by an aligning washer 34, which is supported on the armature pin 10. At the end of the armature pin 10 oriented away from the aligning washer 34, there is a disk-shaped stop 38 of the armature pin 10, which strikes against the lower end surface of the disk-shaped mount 66 of the elongated armature guide 28. The disk-shaped stop 38 of the armature pin 10 is encompassed by the size-classified aligning washer 56. The size-classified aligning washer 56 in turn rests against an end surface 58 of an injection valve member guide 59. Inside the injection valve member guide 59, there is a control chamber 48 that is acted on with highly pressurized fuel via an inlet throttle 50 and can be depressurized via an outlet throttle 46. The outlet throttle 46 can be opened or closed by means of a closing element 42, which is embodied as spherical in the exemplary embodiment shown in FIG. 2. In the injection valve member guide 59, in the region of the outlet throttle 46, a seat 44 is provided for the closing element 42 that is embodied as spherical here. The spherically embodied closing element 42 is encompassed by a guide body 40 that is subjected to force by the lower end of the armature pin 10.

Upon depressurization of the control chamber 48 when the spherically embodied closing element 42 is opened after actuation of the electromagnet 32, a pressured decrease occurs in the control chamber 48, resulting in an opening motion of the needle-shaped injection valve member 60. As a result, injection openings at the bottom of the fuel injector, which is only partially depicted here, are opened so that highly pressurized fuel can be injected from the combustion chamber end of the fuel injector into the combustion chamber of the internal combustion engine.

It is clear from FIG. 2 that the elongated embodiment of the armature guide 28 on the one hand makes it possible to significantly decrease the distance 54 between the force engagement point of the valve spring 24 and the top of the elongated armature guide 28, thus decisively reducing the lateral forces that the valve spring 24 introduces with respect to the armature pin 10. It is also clear from FIG. 2 that by contrast with embodiments according to prior art, the armature plate 70 is now accommodated not on the armature pin 10, but on the outer circumference surface of the neck 29 of the elongated armature guide 28. Thanks to this placement, a possibly occurring tilting of the armature plate 70 with respect to the symmetry axis of the armature pin 10 is not transmitted to the armature pin 10, but is instead absorbed by the neck 29 of the elongated armature guide 28.

For the sake of completeness, it should be noted that the clamping screw 52 snugly attaches the injection valve member guide 59 to the injector body 30 of the fuel injector at a seat 62.

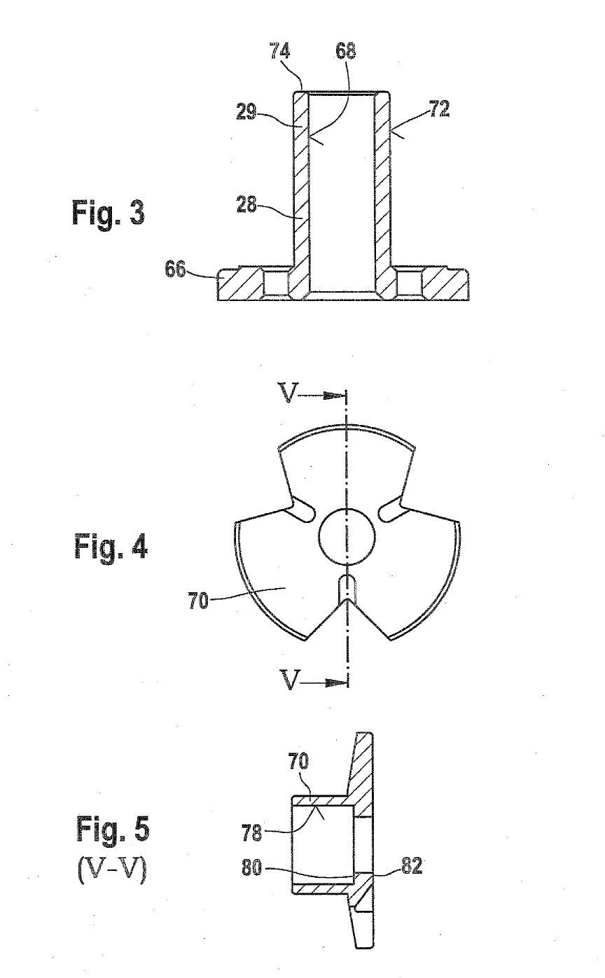

It is clear from the component depiction of the elongated armature guide shown in FIG. 3 that the elongated armature guide 28 has the disk-shaped mount 66 already mentioned in connection with FIG. 2 and a neck section 29 extending in the axial direction. Its outer circumference surface serves as a guide surface 72 for the armature plate 70, not shown in FIG. 3, of the two-part armature subassembly. In addition, at the upper end surface of the neck section of the elongated armature guide 28, an excess stroke stop 74 for the armature plate 70 is provided. The excess stroke stop 74 of the elongated armature guide 28 cooperates with a complementarily embodied stop on the armature plate 70 (see depiction according to FIG. 5).

While the outer circumference surface of the neck section of the armature guide 28 serves as a guide surface 72 for the armature plate 70, the inner circumference surface of the elongated armature guide 28 constitutes a guide surface 68 for the armature pin 10 that is also not shown in FIG. 3, but can be inferred from FIG. 2. Thanks to the elongation of the armature guide 28 in the axial direction, the armature pin 10 according to FIG. 2, which is guided on the guide surface 68 of the elongated armature guide 28, is guided over a longer axial length inside the armature guide 28 and this circumstance alone reduces the tilting of the armature pin 10 resulting from the guidance play 18. The reduced tilting also reduces the unused armature stroke distance AAH since it is in direct geometrical proportion to the tilt.

FIG. 4 shows an armature plate with a section V-V that is shown in FIG. 5.

It is clear from FIGS. 4 and 5 that an armature plate 70, which is mounted on the armature pin 10 shown in FIG. 2, is embodied as wing-shaped and in the exemplary embodiment according to FIG. 4, has three wings. The sectional view according to FIG. 5 shows that the armature plate 70 in turn has an excess stroke stop 80 that cooperates with the excess stroke stop 74 at the upper end of the elongated armature guide 28 according to FIG. 3. In addition, a guide surface 78 is embodied on the inside of the armature plate 70 and cooperates with the outer circumference surface of the elongated armature guide 28 according to the depiction in FIG. 3, see reference numeral 72 therein. Depending on the production quality and the concentricity between the guide surface 78 on the inside of the armature plate 70 and the machining quality of the guide surface 72, i.e. the outer circumference of the elongated armature guide 48, it is possible to achieve a high-precision guidance of the armature plate 70 against the elongated armature guide 28. In order to move the armature pin 10 upward in opposition to the action of the valve spring 24, the magnetic force, which acts as a pulling force on the armature plate 70, is transmitted via a transmitting surface 82 into the aligning washer 34 and therefore into the armature pin 10.

The function of the elongated armature guide 28 is to guide the armature pin 10 on its inside and to provide a mount inside the injector. The excess stroke stop 74 on the elongated armature guide 28 is shifted upward. In the embodiment according to the invention, the function of the guidance of the armature plate 70 is therefore no longer performed by the armature pin 10, but instead by the elongated armature guide 28. To this end, the elongated armature guide 28 is provided with the additional functional surface in the form of the guide surface 72 on its outer diameter. The armature plate 70 has the function of absorbing the magnetic force generated by the electromagnet 32, of transmitting it via the transmitting surface 82 to the aligning washer 34 and therefore the armature pin 10 in order to open the valve, of constituting the guide surface 78 against the outer circumference surface, i.e. the guide surface 72 of the elongated armature guide 28, of transmitting the opening force to the armature pin 10, and of providing an excess stroke stop, namely the excess stroke stop 80. By contrast with embodiments known from the prior art, in the embodiment according to the invention, the armature plate 70 is not guided directly on the armature pin 10, but is instead guided on the elongated armature guide 28 and its neck region. This increases the inner diameter of the guidance of the armature plate 70, with the guidance being provided by the guide surface 72 on the neck region of the elongated armature guide 28 and by the guide surface 78 on the inside of the neck 29 of the armature plate 70.

1-9. (canceled)

10. A fuel injector with a solenoid valve, which actuates a multi-part armature subassembly comprising an armature plate, an armature guide, and an armature pin acted on by a valve spring, and, by means of a stroke motion of the armature pin, a closing element is opened or closed in order to depressurize a control chamber, thus making it possible to actuate an injection valve member, the improvement wherein the armature plate is guided on the armature guide in such a way that it is decoupled from the armature pin.

11. The fuel injector according to claim 10, further comprising an end surface of the armature guide serving as an excess stroke stop and being situated spaced a reduced distance apart from the force introduction point of the valve spring.

12. The fuel injector according to claim 10, further comprising a guide surface on the armature guide, the armature plate being guided on the guide surface.

13. The fuel injector according to claim 11, further comprising a guide surface on the armature guide, the armature plate being guided on the guide surface.

14. The fuel injector according to claim 10, wherein the armature plate comprises a transmitting surface for transmitting the magnetic force to the armature pin.

15. The fuel injector according to claim 11, wherein the armature plate comprises a transmitting surface for transmitting the magnetic force to the armature pin.

16. The fuel injector according to claim 12, wherein the armature plate comprises a transmitting surface for transmitting the magnetic force to the armature pin.

17. The fuel injector according to claim 10, further comprising a spring element supported between a sleeve-shaped extension of the armature plate and a disk-shaped mount of the armature guide, the spring element prestressing the armature plate.

18. The fuel injector according to claim 11, further comprising a spring element supported between a sleeve-shaped extension of the armature plate and a disk-shaped mount of the armature guide, the spring element prestressing the armature plate.

19. The fuel injector according to claim 12, further comprising a spring element supported between a sleeve-shaped extension of the armature plate and a disk-shaped mount of the armature guide, the spring element prestressing the armature plate.

20. The fuel injector according to claim 14, further comprising a spring element supported between a sleeve-shaped extension of the armature plate and a disk-shaped mount of the armature guide, the spring element prestressing the armature plate.

21. The fuel injector according to claim 1O, wherein a guidance play prevails between the armature guide and the armature pin, and wherein the armature guide is elongated in the axial direction to minimize the tilt of the pin with respect to a main injector axis of the fuel injector.

22. The fuel injector according to claim 11, wherein a guidance play prevails between the armature guide and the armature pin, and wherein the armature guide is elongated in the axial direction to minimize the tilt of the pin with respect to a main injector axis of the fuel injector.

23. The fuel injector according to claim 12, wherein a guidance play prevails between the armature guide and the armature pin, and wherein the armature guide is elongated in the axial direction to minimize the tilt of the pin with respect to a main injector axis of the fuel injector.

24. The fuel injector according to claim 10, further comprising a first guide surface on the outer circumference surface of the armature guide and a second guide surface of the armature plate, the first and second guide surfaces and an inner circumferential surface of the armature guide being embodied with a heightened surface quality.

25. The fuel injector according to claim 12, wherein the guide surface provides the armature plate with a guidance that is stationary with respect to the injector body and independent of the movement of the armature pin.

26. The fuel injector according to claim 13, wherein the guide surface provides the armature plate with a guidance that is stationary with respect to the injector body and independent of the movement of the armature pin.

27. The fuel injector according to claim 10, wherein the armature guide comprises an elongated neck section whereby lateral forces between the armature pin and the armature guide are minimized.

28. The fuel injector according to claim 11, wherein the armature guide comprises an elongated neck section whereby lateral forces between the armature pin and the armature guide are minimized.

29. The fuel injector according to claim 12, wherein the armature guide comprises an elongated neck section whereby lateral forces between the armature pin and the armature guide are minimized.
